(19) United States
(12) Patent Application Publication
(10) Pub. No.: US 2015/0045977 A1
(43) Pub. Date: Feb. 12, 2015

(54) METHOD AND APPARATUS FOR USING PLC-BASED SENSOR UNITS FOR COMMUNICATION AND STREAMING MEDIA DELIVERY, AND FOR MONITORING AND CONTROL OF POWER USAGE OF CONNECTED APPLIANCES

(71) Applicants: Mingyao XIA, Shenzhen (CN); Eric Grubel, Thousand Oaks, CA (US); Dan Castellano, Cupertino, CA (US)

(72) Inventors: Mingyao XIA, Shenzhen (CN); Eric Grubel, Thousand Oaks, CA (US); Dan Castellano, Cupertino, CA (US)

(21) Appl. No.: 14/305,988

(22) Filed: Jun. 16, 2014

(30) Foreign Application Priority Data
Jun. 17, 2011 (US) PCT/US2011/040940

(51) Int. Cl. H04B 3/54; G05F 1/66; H04L 12/28

(52) U.S. Cl. CPC H04B 3/54; H04L 12/2825; G05F 1/66; H04L 2012/2843
USPC 700/295

(57) ABSTRACT

A group of sensors use power line communication (PLC) technology to collect power usage information and enable power management and control, as well as provide local area networking. The sensors include an intelligent master sensor and one or more slave devices, such as a communication and power management sensor and a power control switch sensor. The master collects and compiles power usage data from the slaves and communicates this data via the web or other communication means to the outside world. The master also receives and distributes instructions for controlling power usage via associated switches in the home or office. These sensors provide integrated sensing and control of home power usage and power management and establish a LAN that has communication capability and that supports streaming media delivery.

### CROSS REFERENCE TO RELATED APPLICATIONS

This application is a Continuation of U.S. application Ser. No. 13/032,454, entitled Method and Apparatus For Using PLC-Based Sensor Units For Communication and Streaming Media Delivery, and For Monitoring and Control Of Power Usage Of Connected Appliances, filed 22 Feb. 2011, which is incorporated herein in its entirety by this reference thereto.

This Application is also related to PCT/US2011/40940, filed Jun. 17, 2011.

### BACKGROUND OF THE INVENTION

1. Technical Field

The invention relates to power line networking, with remote power monitoring and control of appliances, within a local area network. More particularly, the invention relates to reducing the carbon foot print of in-home appliances by using appropriate devices for power monitoring, data collection, and control and communication over power lines.

2. Description of the Background Art

The communication of information over power lines has been known from the early 20^{th} century but, due to the higher cost and other limitations for extending the connectivity, the use of such power line communication (PLC) systems has been limited to local area networks within homes, apartments, or offices. Basic devices for connecting to the power line for communication and power supply have been designed and used to provide service within local area networks (LANs). But, due to more efficient competing technologies, the infrastructure for power line communication never developed to make it a mainstream technology. A number of patents and patent applications dating from the early 1900s exist that cover communication via power lines. Despite this early start, power line communication technology has not become a main stream communication technology and the adaptation of this technology has been slow. This can be attributed to various reasons, including the higher cost of available devices and the lack of suitable devices for communication using power line technology. Thus, there are no power line devices currently available that can compete efficiently for standard voice and data communication against such technologies as xDSL, cell phones, and satellite communications.

It be advantageous to provide an application with which power line communication technology can be optimally used, and to develop devices that cater to such application for the future growth and development of the power line communication technology to bring forth its potential.

### SUMMARY OF THE INVENTION

A method and apparatus are described in which a group of sensors use power line communication (PLC) technology to collect power usage information and enable power management and control, as well as local area networking for a home or office environment. The sensors include an intelligent master sensor and one or more slaves, such as a communication and power management sensor and a power control switch sensor. The master collects and compiles power usage data from the slaves and communicates the power usage data to the outside world via the web or other communication means. The master also receives and distributes instructions for controlling power usage via associated switches in the home or office. These sensors provide integrated sensing and control of home power usage and power management, and establish a LAN that has communication capability and that supports streaming media delivery.

### BRIEF DESCRIPTION OF THE DRAWINGS

FIG. 1 is a block schematic diagram showing a power switch unit (SW) having a broadband information transfer capability according to the invention;

FIG. 2 is a block schematic diagram showing a power switch unit (SW) having a narrowband information transfer capability according to the invention;

FIG. 3 is a block schematic diagram showing a data communication enabled power switch unit (ETH) having broadband for PLC and narrowband for monitor and control information transfer according to the invention;

FIG. 4 is a block schematic diagram showing a data communication enabled power switch unit (ETH) having broadband for PLC and for monitor and control information transfer according to the invention;

FIG. 5 is a block schematic diagram showing a data communication enabled power switch unit (ETH) having broadband for PLC and for monitor and control information transfer according to the invention;

FIG. 6 is a block schematic diagram showing a master unit (MST) having a broadband connection for the Internet and PLC data, and for monitor and control information according to the invention;

FIG. 7 is a block schematic diagram showing a master unit (MST) having a broadband connection for the Internet and PLC data, and a narrowband connection for monitor and control information according to the invention; and

FIG. 8 is a block schematic diagram showing the connections that are established when using the SW, ETH, and MST in a home or office setting according to the invention.

### DETAILED DESCRIPTION OF THE INVENTION

The recent worldwide introduction of new Green technologies and the requirement for end user monitoring and control of a ‘carbon footprint’ of homes and offices has created a need to assess the in-building power usage pattern and magnitude of the usage remotely, and provide the ability to supervise and control the power usage remotely. It is necessary to be able to monitor and control the power usage at a detailed level for the consumer, who is then able to exercise the necessary constraints on use if the proper tools are provided to him. It is also necessary to monitor the usage pattern and collect data on a macro level to develop policies that are beneficial to the overall reduction in ‘carbon footprint’ at the home and office level, as well as on a national level. Empowering the individual and society to exercise the necessary controls by monitoring the power usage is an area where power line communication and control can be effectively and optimally used.

To this end, a method and apparatus are described in which a group of sensors use power line communication (PLC) technology to collect power usage information and enable power management and control, as well as local area networking for a home or office environment. The sensors include an intelligent master sensor and one or more slaves, such as a communication and power management sensor and a power control switch sensor. The master collects and compiles power usage data from the slaves and communicates the power usage data to the outside world via the web or other communication means. The master also receives and distributes instructions for controlling power usage via associated switches in the home or office. These sensors provide integrated sensing and control of home power usage and power management, and establish a LAN that has communication capability and that supports streaming media delivery.

The invention build upon existing communication capability provided by such power line communication (PLC) devices as described by Chan, et al. (U.S. Pat. No. 7,769,908 filed on Mar. 25^{th} 2008, hence forth ‘Chan’), which patent is assigned to a common assignee, and which patent is incorporated herein in its entirety by this reference thereto. The ‘Chan’ PLC devices are enabled to provide capability for communication over power lines.

The invention provides for collection of power usage information and provides for remote control of power usage of appliances and other devices connected to the disclosed sensor devices or units. This above capability is established in addition to the PLC LAN capability made available by use of such communication enabled power monitoring and control devices. Three types of units that enable the monitoring and control of power usage and the collection of power data for the local area networked home or office and their application within the home or office are disclosed. The three units are mainly required for cost reduction by providing appropriate capabilities, as will become clear when the application of the devices are described. The three units that allow these unique features within the home or office include:

1. A power switch sensor unit (SW);
2. A data communication enabled power switch sensor unit, typically using Ethernet (ETH); and
3. A master unit (MST).

Power Switch Sensor (SW)

The SW is one of the basic units of the invention. This allows an appliance in the home or office to be connected to the power outlet through the device. The device provides for the monitoring of power consumption of the appliance with capability for remote power control (typically on/off) of the connected appliance through the Internet.

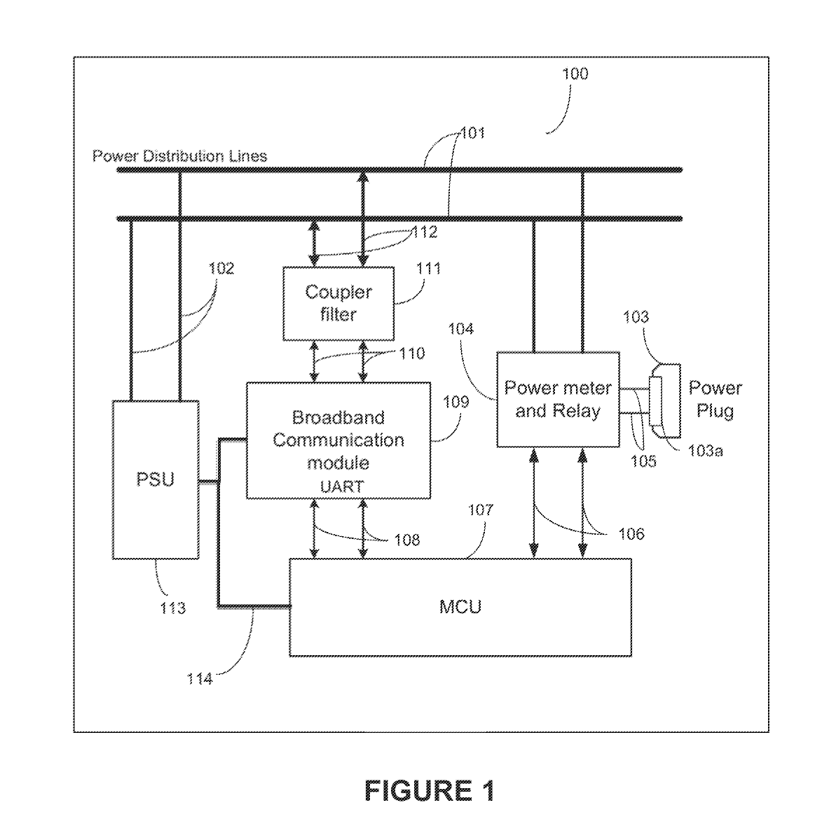

FIG. 1 is a schematic block diagram of a first implementation of a SW unit 100. The main power distribution lines 101 carry power around the home. The power is connected through a power meter and relay module 104, and through the power lines 105 to a power plug 103. Typically the power plug comprises an additional noise filter 103a to remove any noise transmission to the connected appliance and from the appliance to the power meter and relay module. The power meter and relay module 104 optionally includes a power control module. The power supply to the power plug 103 can be enabled or disabled using the relay in the power meter and relay module 104. If the power meter and relay module 104 includes the optional power control module, then the optional power control module controls the amount of power delivered through the plug 103, for example for soft motor start, etc. using the power control function of the power meter and relay module 104.

The power meter in the power meter and relay module 104 continuously monitors the power usage at the plug 103. A communication link 106 connects the power meter and relay module 104 to a microcontroller (MCU) 107 that collects the information regarding power usage from the power meter and relay module 104 for transmission using a communication module 109. The communication module includes a universal asynchronous receiver and transmitter (UART) that is connected to the MCU 107 via communication links 108. The data is converted by the communication module 109 to a broadband format for transmission over the power distribution lines 101. This information is then sent over broadband communication links 110 to a power line coupler filter module 111 which is connected to the power distribution lines 101 via broadband communication links 112. The coupler filter module 111 in an embodiment comprises a high pass filter that allows bidirectional passage for the broadband PLC frequency band, while attenuating the lower frequencies. The broadband format for communication used for transfer of the collected information on power usage is the same as that used for PLC data transfer.

Because the communication connections and modules are bidirectional, commands received over the power lines 101 are used by the MCU 107 to provide control of the power meter and relay module 104 to enable or disable the plug 103 and control the power flow through the plug 103. In this instance, the commands are also communicated back to SW 100 using the same broadband communication format typically used for PLC for transfer of power usage information collected. In the case where commands are sent over the PLC for the SW 100, the commands are received by the communication module 109 through the power line coupler filter module 111, which module is connected to the power distribution lines 101. These commands are extracted by the communication module 109 and sent to the MCU 107 via the communication links 108. The MCU 107 then sends the necessary instructions to the power meter and relay module 104 to enable, disable, or control the flow of power to the plug 103, based on the commands received.

Power for the modules in the SW is supplied by an inbuilt power supply module (PSU) 113 that is connected to the power distribution lines 101 through power lines 102. The PSU supplies the power to the modules via power lines 114.

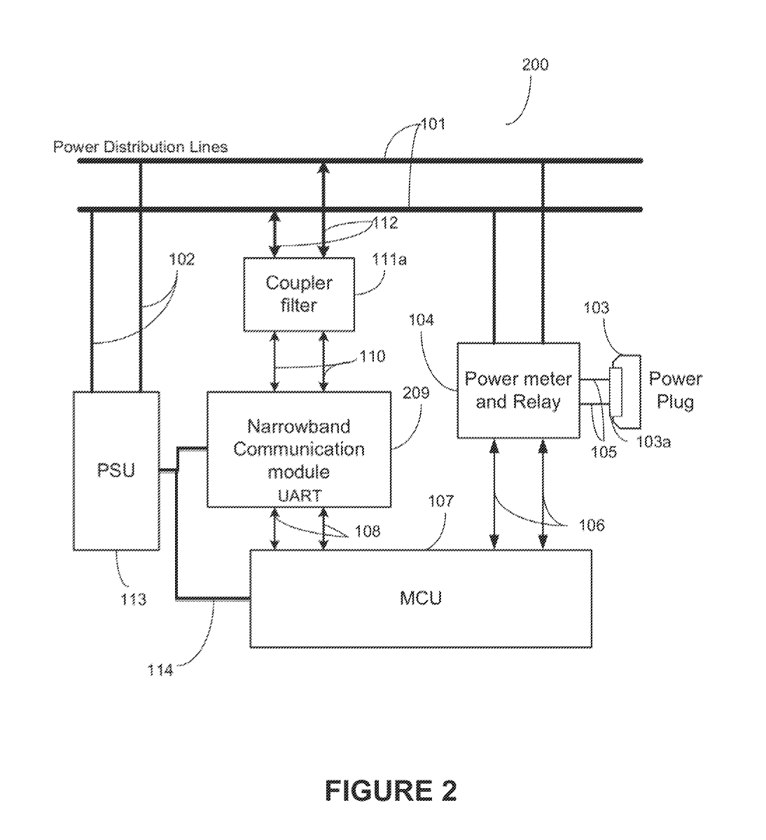

FIG. 2 is a schematic block diagram of a second implementation of the SW unit 200. In this implementation, information on power usage that is collected by the MCU 107 and sent to the communication module 209 is converted for transmission over the power lines 101 as a narrowband transmission format instead of as broadband transmission used for PLC. Similarly, control commands are received over the power line for SW 200 in the narrowband transmission format.

Similar to SW 100, in the SW 200 implementation the main power distribution lines 101 are used to carry power around the home. The power is connected through a power meter and relay module 104, and through the power lines 105 to the power plug 103. The power meter and relay module 104 optionally includes a power control module. The power can be enabled or disabled using the relay in the power meter and relay module 104. If the power meter and relay module 104 has the optional power control module, the module controls the amount of power delivered through the plug 103, for example for soft motor start, etc. using the power control in the power meter and relay module 104.

The power meter in the power meter and relay module 104 continuously monitors the power usage at the plug 103. A communication link 106 connects the power meter and relay module 104 to the MCU 107. The MCU collects the information regarding power usage from the power meter and relay module 104. The collected information is transmitted to a communication module 209 through a UART that is connected to the MCU 107 via communication links 108. The information is converted by the communication module 209 to a narrowband format for transmission over the power distribution lines 101. This information is then sent over communication links 110 to a power line coupler filter module 111a which is connected to the power distribution lines 101 via communication links 112. In this implementation of SW 200, the narrowband format for communication used for transfer of the collected information on power usage is different from the broadband format that is typically used for PLC data transfer. The coupler filter module 111a is a bidirectional band pass filter that allows the narrowband frequencies to pass through while blocking the higher broadband frequencies and the lower power supply frequencies.

The communication connections and modules are bidirectional. Commands received over the power lines 101 provide control of the power meter and relay module 104 to enable or disable the plug 103 and also control the power flow through the plug 103. In this implementation, the commands are communicated back to SW 200 using the same narrowband communication format used for transfer of power usage information collected. The commands are received by the communication module 209 through the power line coupler filter module 111a that is connected to the power distribution lines 101. These commands are extracted by the communication module 209 and sent to the MCU 107 via the communication links 108. The MCU 107 then interprets the commands and sends the necessary instructions to the power meter and relay module 104 to enable, disable, or control the flow of power to the plug 103, based on the commands received.

### Data Communication Enabled Power Switch Module (ETH)

The ETH is the second unit of the invention. This unit allows an appliance in the home or office to be connected to the power supply through the ETH, and provides for the monitoring of power consumption with capability for remote control of the connected appliance. The ETH further provides the capability for data and communication devices to be connected to the power distribution line in the home or office through a connector. The connector used is typically an Ethernet connector. This should not be considered as limiting because other types of connectors are also be used for communications, as is well understood by those knowledgeable in the art. Multiple ETH units can be used to establish a PLC based local area net work (LAN) in the home.

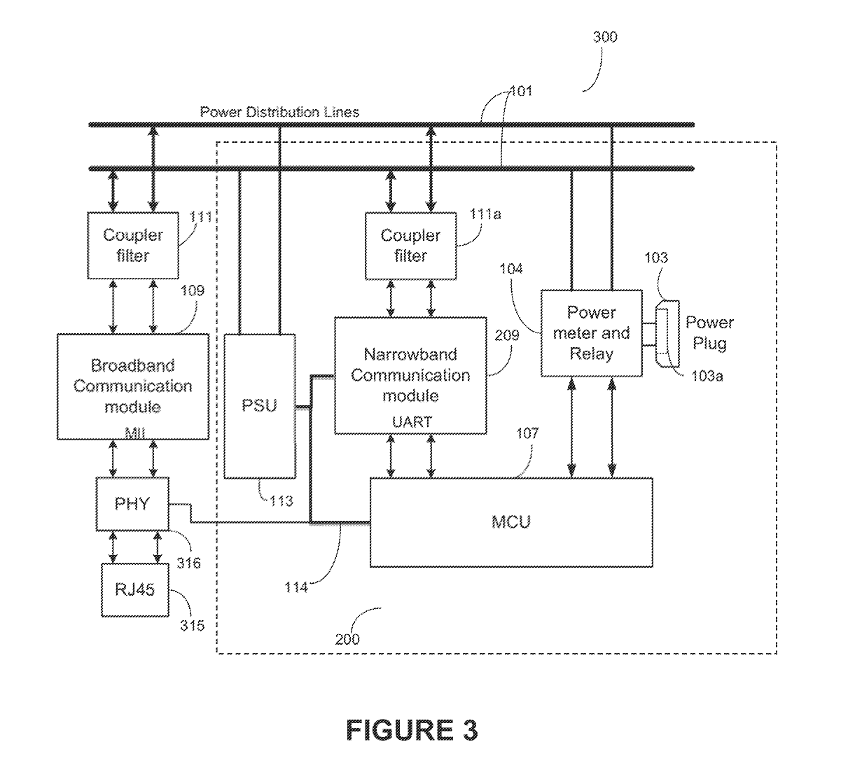

FIG. 3 is a schematic block diagram of a first implementation of the ETH unit 300. The ETH 300 is a combination of two subunits: a broadband PLC subunit, and a SW subunit, for example, SW 200. The SW subunit in this instantiation shown in FIG. 3 uses narrowband communication for information transfer on power usage and control. The ETH block schematic contains all of the PLC broadband communication modules with modules of SW 200 that together form the block schematic of an ETH 300. The block schematic of the SW 200 is the same as in FIG. 2 with narrowband information transfer capability. The operation of the SW 200 subunit of the ETH 300 is as described earlier for the SW 200.

The broadband communication subunit of the ETH 300 typically comprises an RJ45 connector 301 for CAT5 Ethernet cable which is used as a broadband communication I/O connector into the ETH 300. The RJ45 connector 315 is connected through a physical layer interface (PHY) module 316 to a media interface input (MII) on a broadband PLC communication module 309. The communication module 309 converts the analog input into the broadband format that is then passed on to the main power distribution lines 101, through a coupler filter module 111. The main power distribution lines 101 form the LAN within a home or office for data communication. The broadband communication elements are bidirectional and allow any broadband communication meant for a consumer connected to the RJ45 connector 315 to be received by the correct consumer. The data in broadband format is received by the communication device 309 through the coupler filter module 111 from the main power line 101. The communication module 309 converts the received data stream into the analog format and sends it through the MII interface of the communication module 309 to the PHY 316, to the RJ45 module 315, and to the connected customer device. The use of broadband communication within the PLC LAN using the ETH 300 units allows the provision of streaming media delivery capability to connected display devices, connected to appropriate communication units within the PLC LAN.

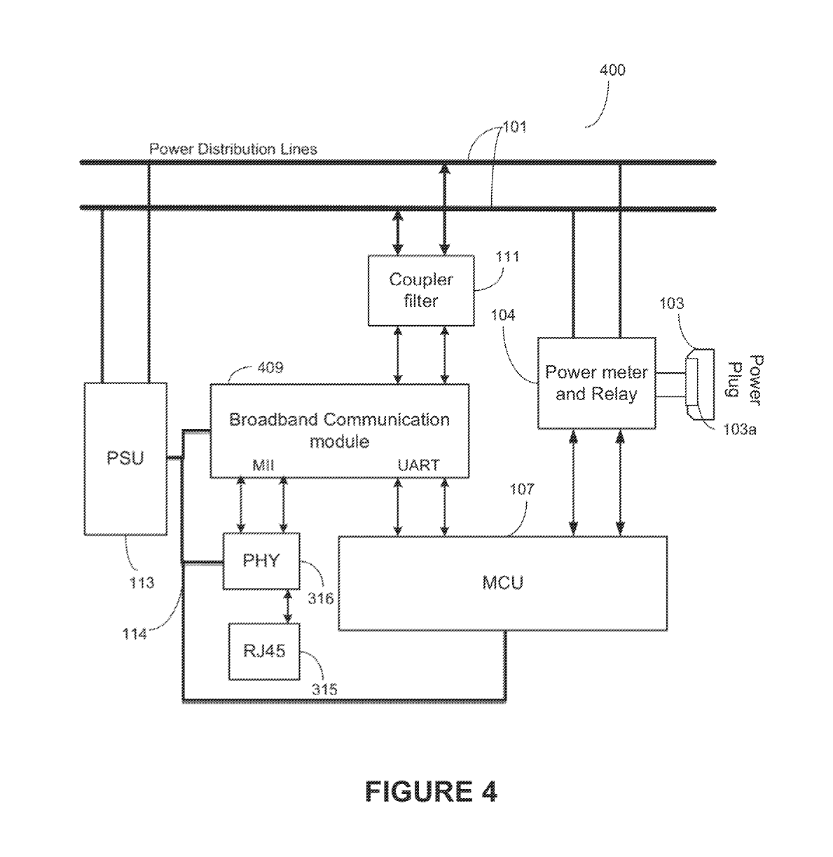

FIG. 4 is a schematic block diagram of a second implementation of the ETH unit 400. The ETH 400 implementation provides data communication capability and power monitoring and control capability. The ETH 400 uses the broadband communication format used by the PLC data communication for data communication over power lines and for transfer of information regarding power monitoring and control. In FIG. 4, the RJ45 connector 315 is connected through the PHY 316 to an MII port on the communication module 409, which is used to convert the incoming data stream into the broadband format used for PLC. This data stream is then transferred from communication module 409 to the power distribution lines 101 in the home or office through the coupler filter module 111. Using multiple ETH 400 units within a home or office enables PLC LAN connectivity within the home or office. Here, also, the disclosed use of broadband communication within the PLC LAN using the units enables streaming media delivery capability to connected display devices, connected to appropriate communication units within the PLC LAN.

The power supply to the plug 103 is from the power distribution lines 101 through the power meter and relay module 104. A noise filter 103a prevents noise transfer to the connected appliance from the ETH, and also prevents the transfer of noise from the appliance to the ETH. The status of the relay and the power monitoring information are collected by the power meter and relay module 104 and passed to the MCU 107, which transfers the information collected to the communication module 409 via a second port with a UART or MII on the communication module 409. This information is also converted by the communication module 409 into the broadband format used for PLC and transferred to the power distribution lines 101 through the coupler filter module 111.

The modules for broadband data communication and power monitoring and control all allow bi-directional flow of data, information, and control commands, enabling the establishment of a broadband PLC based LAN and also enabling remote monitoring and control of the plug. The control commands received over the PLC broadband network are converted to the right data stream format by the communication module 409 and sent to the MCU 107. The MCU 107 interprets these control commands and instructs the power meter and relay module 104 to enable, disable, or control the power to the plug 103 as per the instructions provided.

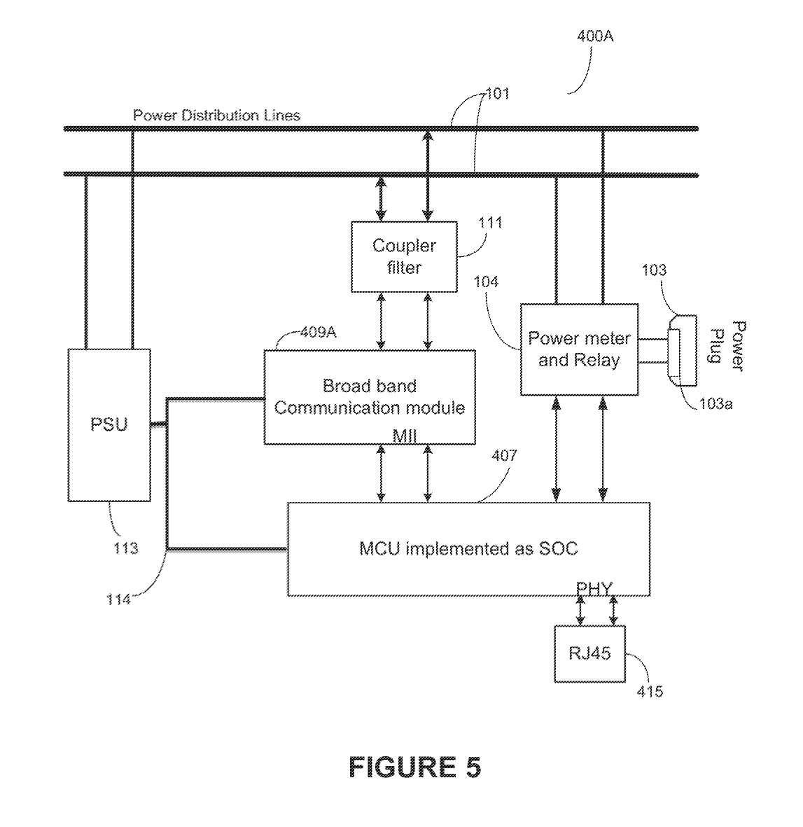

FIG. 5 is a schematic block diagram of a third implementation of ETH unit 400A. This implementation operates in a manner similar to the previously described implementation in FIG. 4, a difference being that the MCU 407 is implemented as an system on chip (SOC) which integrates the communication PHY in the MCU 407. A special port on the MCU 407 is provided for direct connection of the RJ45 connector 415 to the PHY integrated in the MCU 407. The implementation uses a single MII port on the broadband communication module 409A to connect to the MCU 407 for communication and for transfer of information regarding power monitoring and control. The communication module 409A, as in the previous case, uses broadband PLC communication to communicate the data stream and information over the power distribution lines 101.

### Master Unit (MST)

The MST is the third basic unit of the invention and provides the computing power and storage capability necessary to collect and compile power consumption information provided to it. The connected SW units and ETH units monitor the power usage of devices and appliances connected to their respective power plugs. This information is sent over the local power distribution lines in the home or office to the MST for compilation of data on usage. With the capability and computing power available the MST exerts local and emergency control of the appliances connected to the SWs and ETH units. The MST further acts as a gateway connecting to the broadband communication modem to enable a communication pathway to the Internet, thereby connecting to the wide area network [WAN].

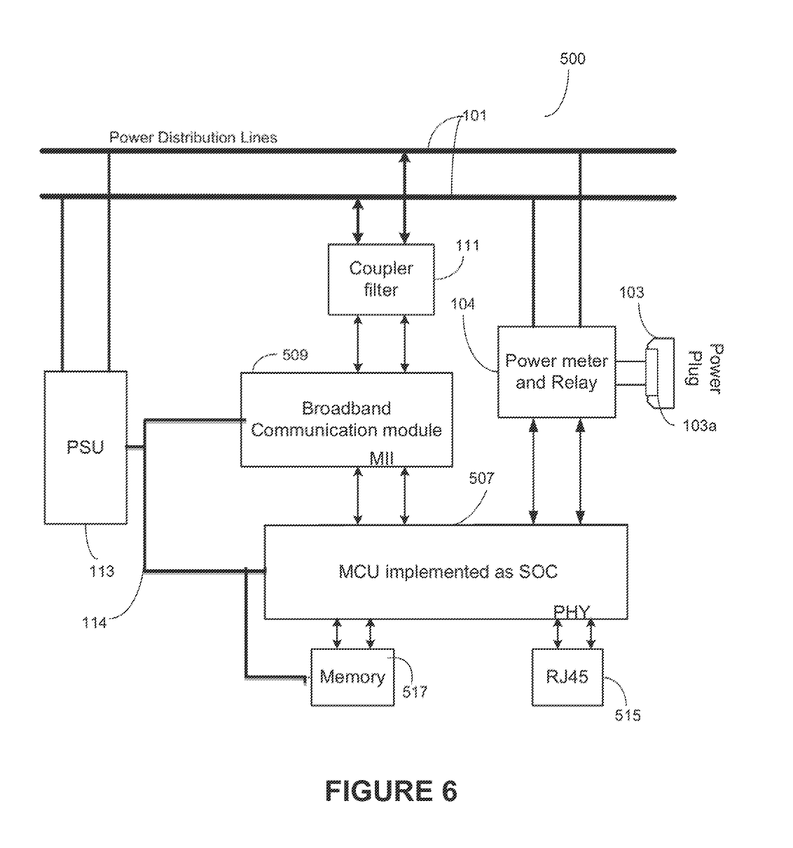

FIG. 6 is a schematic block diagram of a first implementation of MST 500. In this implementation, an MCU having sufficient processing capability, typically a 16- or 32-bit MCU, is implemented as a system on chip (SOC) 507. This SOC 507 implementation provides for higher processing power and integration of modules with the MCU. The SOC 507 integrates the PHY into the MCU, thus allowing the RJ45 connector 515 for connecting the customer's modem device directly to a port on the SOC 507. This connection provides the gateway to the Internet for the PLC LAN for communication from the connected ETH units. The SOC 507 enforces all communication-related security protocols associated with the PLC LAN. Further, all data and power monitoring and control information is provided to the SOC 507 from the connected units via the power distribution lines 101 through the coupler filter module 111 and the communication module 509. The SOC 507 receives the information and processes it for outward transmission to the Web. The SOC 507 also has an associated memory 517, typically connected to a memory port. The memory 517 enables the SOC 507 to store the received power monitoring and control information prior to processing and compiling the information. The memory 517 also stores the compiled information to transmit it out through the gateway optimally when the bandwidth usage for communication is low. The memory 517 also stores transaction history and information on incoming commands. The memory 517 provides for tracking of performance and remote debugging capability for the ETH 500 unit among other uses.

The MST 500 provides a power plug 103, with a noise filter 103a, connected to the power distribution lines 101 through a power meter and relay 104. This power plug 103 supplies power to any needed appliance with the necessary power monitoring and control capability. This monitored information is sent to the MCU implemented as an SOC 507 to be combined with the information received over the PLC LAN over the power distribution lines 101 through the coupler filter module 111 and the communication module 509. This collected information is stored in the memory and compiled and processed for transmission to the monitoring sources in the WAN cloud through the modem connected to the SOC 507 at the RJ45 connector 515. The transfer of the compiled information is typically done in a store and forward manner with storage in the memory 517 to enable best use of the available bandwidth of the gateway.

Remote control commands from via the gateway are received through the RJ45 connector 515 from the connected modem. These control commands are interpreted by the SOC 507 of the MST 500 and sent to the respective SW 100 or ETH 400 units to which it is addressed over the broadband PLC LAN through communication module 509 and coupler filter module 111 for necessary action at the receiving units.

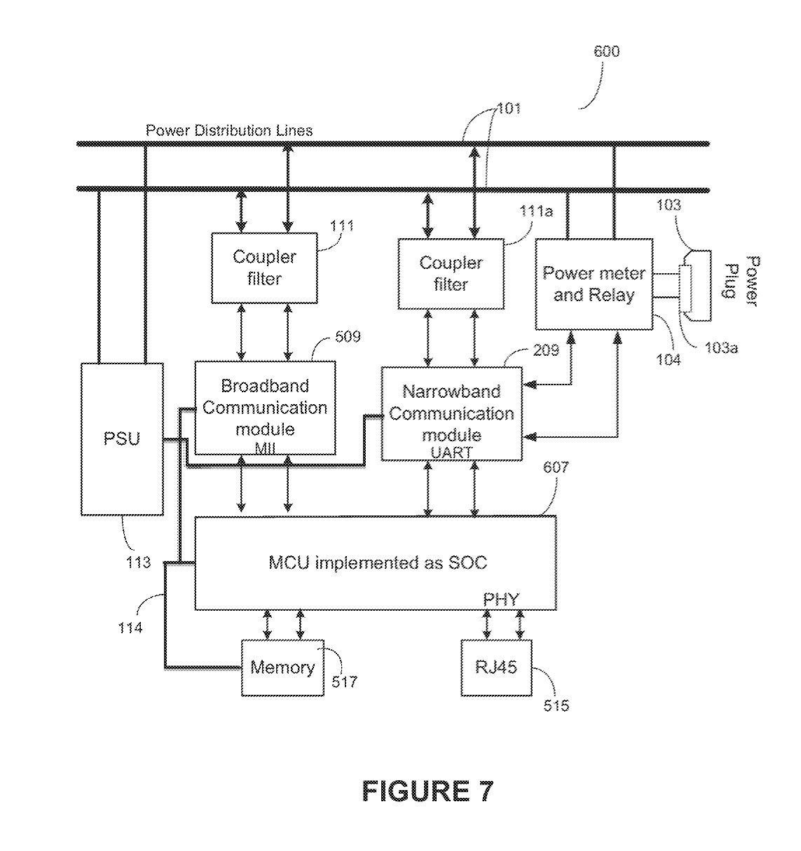

FIG. 7 is a block schematic diagram of a second implementation of the MST 600. This implementation also uses an MCU, preferably a 32-bit MCU, manufactured as a SOC 607. One difference between the previous implementation of the MST 500 and this implementation of the MST 600 is that the MST 600 uses narrowband transmission and reception of power monitoring and control information and broadband PLC for communication. This separation is at times advantageous, especially when the available broadband bandwidth is necessary for communication within the PLC LAN. Once the collected information is received by the SOC 607 it compiled, stored, and transmitted out to the modem via the RJ45 connector 515 on the SOC 607 as in the previous case of MST 500.

Remote Control commands are received by the SOC 600 and transmitted back to the respective connected SW 200 and ETH 300 units with narrowband capability over narrowband communication channel. Data communication is handled using broadband PLC channel over the power distribution lines, as in the case of MST 500.

The MST 600 also has a power plug 103 with a noise filter 103a, connected through a power meter and relay 104. The power meter and relay 104 is used to monitor and control the power supply to any device connected to the plug 103. The monitored power usage information is fed to the MCU implemented in the SOC 607. Monitored power information from other SW and ETH units is sent over the power distribution lines 101 using the narrowband communication capability, to be received by the narrowband communication module 209. A coupler filter module 111a prevents power frequency and broadband communication frequency coupling to the narrowband communication module 209. The narrowband communication module 209 extracts the information from the communication stream and supplies it to the MCU in the SOC 607. The received information is combined with the local information and stored in the memory 517 prior to processing. This stored information is retrieved, compiled, and processed by the MCU based on predefined criteria and transmitted out to the appropriate site in the WAN cloud through RJ45 connector 515 and the broadband modem attached to it.

Any remote commands received via the gateway are received through the RJ45 connector 515 from the connected modem. These control commands are interpreted by the SOC 607 of the MST 600 and sent to the communication module 209 to be converted to the narrowband transmission format for sending over the power distribution lines 101. The commands are then sent through the coupler filter 209 to the power distribution lines 101 to be sent to the respective narrowband enabled SW 200 or ETH 300 units to which it is addressed for necessary action at the receiving units.

The MST 600 also acts as the gateway for communication, linking the PLC LAN system with the WAN cloud. The ETH units connected to customer communication devices send data streams over the power distribution lines 101 using a PLC specific broadband format. The communication module 111 of the MST 600 receives the data streams and extracts the data. This data is then sent to the MCU integrated into the SOC 607 where it is checked for permissions. The data is then sent to the modem connected to the RJ45 connector for transport over the Internet. Because all of the communication modules in this embodiment are bidirectional, the MST can receive data from the Internet through the connected modem and direct the data to the appropriate ETH units over the PLC LAN.

### Typical Connection for the Units as a Complete System

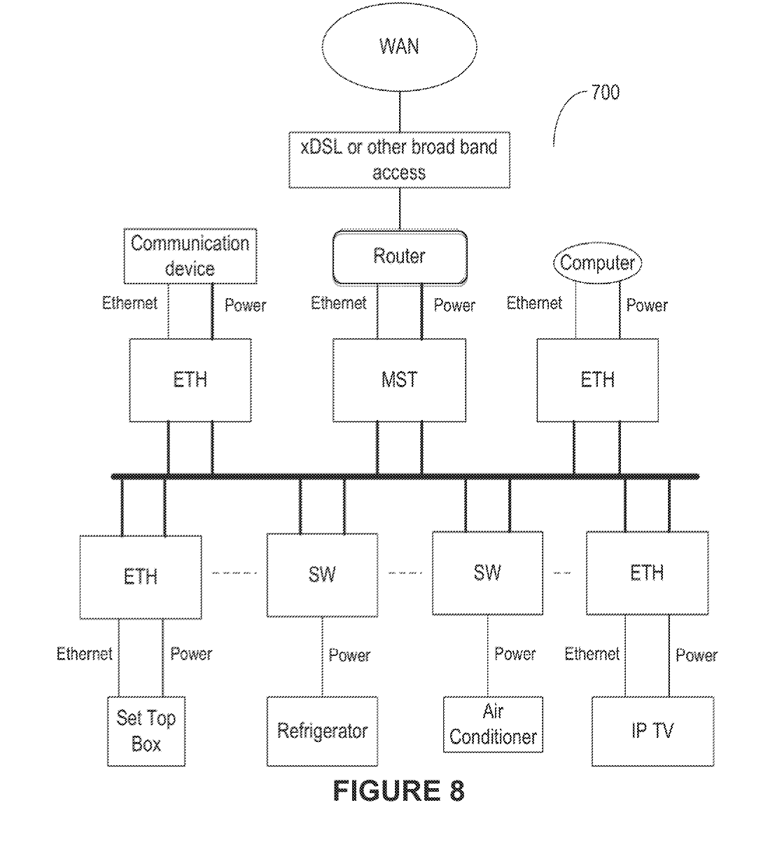

FIG. 8 is a schematic block diagram showing powered management and communication connectivity 700 using the three units of the invention. The SW units are used where the requirement is for power connection capability with monitoring and control, but without the need to connect a communication device into the PLC LAN. The ETH devices also provide communication device connections to the PLC LAN, while providing a power plug or power source which can be monitored and controlled. Multiple SW and ETH units can be used to establish the power monitoring and control for the home and provide connectivity for data communication on the PLC LAN level.

The use of a single MST for the home provides the capability to establish a WAN gateway that enables the PLC LAN to communicate with the outside world using security and connection rules. The MST is also used as a collection and compilation point for the power monitoring function where the power usage within the home with connected SW and ETH units are received and compiled. Because there is connectivity with control capability on each SW and ETH unit, the power delivery through each of these SW and ETH units can be monitored and controlled from any of the communication devices connected to the PLC LAN. Further, this collected information on any of the power plugs can be accessed from the WAN cloud using connected communication devices to monitor the status and provide remote control commands through the WAN gateway. This capability is controlled by the permissions, authorizations, and security rules established for connection into the PLC LAN through the MST.

Because communication connections to the outside world through the MST gateway, and within the PLC LAN via the ETH, are all broadband enabled, the system can provide steaming media capability within the PLC LAN. It can access and enable streaming media delivery to display devices connected using ETH units through the WAN gateway. Hence, the system enables and supports applications such as IP TV and video conferencing that use video streaming.

The system is also enabled to facilitate macro level collection and compilation of power usage information. For this, the collected power monitoring and usage information is transmitted over the WAN gateway to one or more central power usage collection units. These units collect the data for analysis and provide input to the public bodies for making policy decisions on ‘greenhouse gas’ reduction requirements.

Although the invention is described herein with reference to the preferred embodiment, one skilled in the art will readily appreciate that other applications may be substituted for those set forth herein without departing from the spirit and scope of the present invention. For example, the units may be implemented as an assembly of individual components, as a combination of components and integrated circuits or as one or more SOCs. Accordingly, the invention should only be limited by the Claims included below.

1. An apparatus comprising:
a master switch unit (MST) including a processor, a broadband communication module coupled between the processor and a power distribution line, and a memory associated with the processor; and
a communication enabled switch unit (ETH) coupled to the power distribution line, wherein the ETH is configured for any of monitoring, collection, or control of power usage of an appliance connected through the ETH, via a power plug having a noise filter, to the power distribution line;
wherein a local area network (LAN) is established between the ETH and the MST over the power distribution line, the LAN having a broadband communication frequency;
wherein the broadband communication module is configured to modulate signal frequencies between the MST and the LAN;
wherein the MST is coupled to a wide area network (WAN) gateway;
wherein the processor is configured to
receive any of data, power monitoring, or control information from the ETH through the broadband communication module from the LAN,
store the received data, power monitoring or control information in the memory,
process the stored data, power monitoring or control information, and
transmit the processed data, power monitoring or control information over the WAN gateway;
wherein the processor is further configured to
receive any of a data signal, a control command, or a streaming media signal over the WAN gateway,
process the received data signal, command signal, or streaming media signal, and
transmit the received data signal, command signal, or streaming media signal to the ETH over the LAN.

2. The apparatus of claim 1, wherein the ETH is further configured to
process the data signal, command signal, or streaming media signal, and
transfer the processed data signal, command signal, or streaming media signal to the appliance.

3. The apparatus of claim 1, wherein the MST is further configured for any of monitoring or control of power usage of a local appliance that is connected through the MST, via a power plug having a noise filter, to the power distribution line.

4. The apparatus of claim 3, wherein the processor is further configured to
collect any of data, power monitoring, or control information for the local appliance, and
combine the collected data, power monitoring, or control information for the local appliance with the received data, power monitoring, or control information received from the ETH.

5. The apparatus of claim 1, wherein the broadband communication module is coupled to the power distribution line via a filter coupler that is a band pass filter enabled to pass broad band inputs between the broadband communication module and the power distribution line.

6. The apparatus of claim 1, wherein the MST and the ETH are configured for any of communication and streaming media delivery.

7. The apparatus of claim 1, wherein the MST further comprises a port, wherein the MST is coupled to the WAN gateway through the port.

8. The apparatus of claim 1, wherein the WAN gateway comprises an internet modem.

9. The apparatus of claim 1, wherein the MST is further configured to exert any of local or emergency control for an appliance connected to the ETH.

10. The apparatus of claim 1, wherein the MST is configured to enforce a communication-related safety protocol.

11. A communication system comprising:
a master switch unit (MST) including a processor, a broadband communication module coupled between the processor and a power distribution line, and a memory associated with the processor; and
a communication enabled switch unit (ETH) coupled between the power distribution line and a communication device;
wherein a local area network (LAN) is established between the ETH and the MST over the power distribution line, the LAN having a broadband communication frequency;
wherein the broadband communication module is configured to modulate signal frequencies between the MST and the LAN;
wherein the MST is coupled to a wide area network (WAN) gateway;
wherein the processor is configured to
receive at least one of communication data or streaming media data over the WAN gateway,
process the received communication data or streaming media data, and
transmit the received communication data or streaming media data to the ETH, through the broadband module and over the LAN at the broadband frequency;
wherein the processor is further configured to
receive at least one of a communication signal or a streaming media signal from the ETH over the LAN at the broadband frequency, and through the broadband communication module,
process the received communication signal or streaming media signal,
transmit the processed communication signal or streaming media signal over the WAN gateway.

12. The communication system of claim 11, wherein the communication device is connected through the ETH to the power distribution line, via a power plug having a noise filter, and wherein the ETH is configured for any of monitoring, collection, or control of power usage of the communication device.

13. The communication system of claim 11, wherein the communication device is configured to display the streaming media data.

14. The communication system of claim 11, wherein the system enables and supports any of IP TV or video conferencing.

15. The communication system of claim 1, wherein the MST further comprises a port, wherein the MST is coupled to the WAN gateway through the port.

16. The communication system of claim 1, wherein the WAN gateway comprises an internet modem.

17. The communication system of claim 1, wherein the WAN gateway is connected to the internet.

18. A system comprising:
a master switch unit (MST) including a processor, a broadband communication module coupled between the processor and a power distribution line, a narrowband communication module coupled between the processor and a power distribution line, and a memory associated with the processor; and
a communication enabled switch unit (ETH) coupled to the power distribution line, wherein the ETH is configured for any of monitoring, collection, or control of power usage of an appliance connected through the ETH, via a power plug having a noise filter, to the power distribution line;
wherein a local area network (LAN) is established between the ETH and the MST, the LAN having a broadband communication frequency and a narrowband communication frequency;
wherein the broadband communication module is configured to modulate signal frequencies between the MST and the broadband frequency of the LAN;
wherein the narrowband communication module is configured to modulate signal frequencies between the MST and the narrowband frequency of the LAN;
wherein the MST is coupled to a wide area network (WAN) gateway;
wherein the processor is configured to
receive any of power monitoring information or control information from the ETH through the narrowband communication module from the power distribution line, over the narrowband communication frequency,
receive communication information from the ETH through the broadband communication module from the power distribution line, over the broadband communication frequency,
store the received communication information, power monitoring information or control information in the memory,
process the stored communication information, power monitoring information or control information, and
transmit the processed communication information, power monitoring information or control information over the WAN gateway;
wherein the processor is further configured to
receive any of a data signal, a control command, or a streaming media signal over the WAN gateway,
process the received data signal, command signal, or streaming media signal, and
transmit the received data signal or streaming media signal to the ETH, through the broadband communication module and the power distribution line to the ETH, at the broadband frequency, and
transmit the command signal to the ETH, through the narrowband communication module and the power distribution line to the ETH, at the narrowband frequency.
